(19) United States
(12) Patent Application Publication
(10) Pub. No.: US 2008/0072975 A1
(43) Pub. Date: Mar. 27, 2008

(54) Oil pressure control valve having actuator

(75) Inventor: Tsuguo Sugiura, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/790,964

(22) Filed: Apr. 30, 2007

(30) Foreign Application Priority Data
Sep. 21, 2006 (JP) 2006-256059

(51) Int. Cl. B01D 27/04

(52) U.S. Cl. 137/544

(57) ABSTRACT

An oil pressure control valve is composed of a three-way valve and an electromagnetic actuator for driving the three-way valve. An oil port such as a bleed port is formed in an elongated valve housing to open to a radial direction of the valve housing. The oil port is covered with a filter to prevent foreign particles contained in oil from entering the valve housing. The filter is formed in a closed cylindrical shape before it is mounted on the valve housing. The filter is sandwiched between a radial step formed on the valve housing and the electromagnetic actuator connected to the valve housing to prevent movement of the filter in the axial direction. The filter is easily mounted on the valve housing without using any additional members. An axial position of the filter is firmly maintained without being moved by oil pressure or vibration.

### CROSS-REFERENCE TO RELATED APPLICATION

This application is based upon and claims benefit of priority of Japanese Patent Application No. 2006-256059 filed on Sep. 21, 2006, the content of which is incorporated herein by reference.

### BACKGROUND OF THE INVENTION

1. Field of the Invention

The present invention relates to an oil pressure control valve connected to an actuator.

2. Description of Related Art

An oil pressure control valve composed of a valve portion such as a ball valve or a spool valve and an actuator portion such as an electromagnetic actuator has been known hitherto. An oil port directed to a direction perpendicular to an axial direction of the valve portion is formed in many of such valve portions. An example of an oil filter for preventing foreign particles contained in oil from entering into the valve portion through such an oil port is disclosed in JP-A-2006-22816.

JP-A-2006-22816 discloses three alternative ways of mounting the filter covering the outlet port: (1) A shallow groove in which a filer is disposed is formed on an outer periphery of a valve housing. A stud for engaging a filter band is formed on the groove. One end of the filter band is engaged with the stud, and the other end of the filter band is engaged with the stud after the filter is wound around the groove; (2) A filter sheet is wound around a valve housing, and the filter sheet is formed in a circular shape and held around the valve housing by connecting ends of the filter sheet by welding such as spot welding; and (3) A filter is wound around a circular groove formed on an outer periphery of a valve housing, and the filter is held in the groove by a frame formed separately from the valve housing.

However, in the three ways of mounting the filter around the valve housing, respective disadvantages are involved. In the first way, it is necessary to provide a stud on the valve housing, requiring an additional manufacturing cost. In the second way, it is not easy to perform a welding process while keeping a filter in a shape wound around the valve housing. In the third way, an additional space for disposing the frame is necessary.

### SUMMARY OF THE INVENTION

The present invention has been made in view of the above-mentioned problem, and an object of the present invention is to provide an improved oil pressure control valve, in which an oil filter is easily and fixedly mounted on a valve housing.

The oil pressure control valve is composed of a valve such as a three-way valve and an actuator such as an electromagnetic actuator. The three-way valve and a valve shaft are disposed in an elongated valve housing, and the three-way valve is operated by the valve shaft which is driven by the electromagnetic actuator. An oil port open to a radial direction of the valve housing is formed on the valve housing. A filter that prevents foreign particles contained in oil from entering into the valve housing is disposed to cover the oil port.

The filter is formed in a closed cylindrical shape before it is mounted on the valve housing. The filter is mounted on the valve housing by inserting a filter-mounting surface into the filter before the electromagnetic actuator is connected to the valve housing. The filter is sandwiched between a radial step formed around an outer periphery of the valve housing and the electromagnetic actuator not to move in the axial direction.

Since the filter is in a closed cylindrical shape, it closely contacts the filter-mounting surface without being deformed by vibration or oil pressure. The filter can be easily mounted on the valve housing by simply inserting the filter-mounting surface into the cylindrical filter. Since the filter is sandwiched between the radial step and the actuator, it does not move in the axial direction.

Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing an oil pressure control valve as a first embodiment of the present invention;

FIGS. 2A-2C are perspective view showing a circular filter;

FIG. 3 is a drawing for explaining operation of an oil pressure control system that includes an oil pressure control valve of the present invention;

FIG. 4 is a cross-sectional view showing an oil pressure control valve as a second embodiment of the present invention;

FIG. 5A is a perspective view showing an oil filter used in the second embodiment; and

FIG. 5B is a cross-sectional view showing a narrow passage formed by the oil filter in the second embodiment, taken along line VB-VB shown in FIG. 4.

### DETAILED DESCRIPTION OF THE PREFERRED EMBODIMENTS

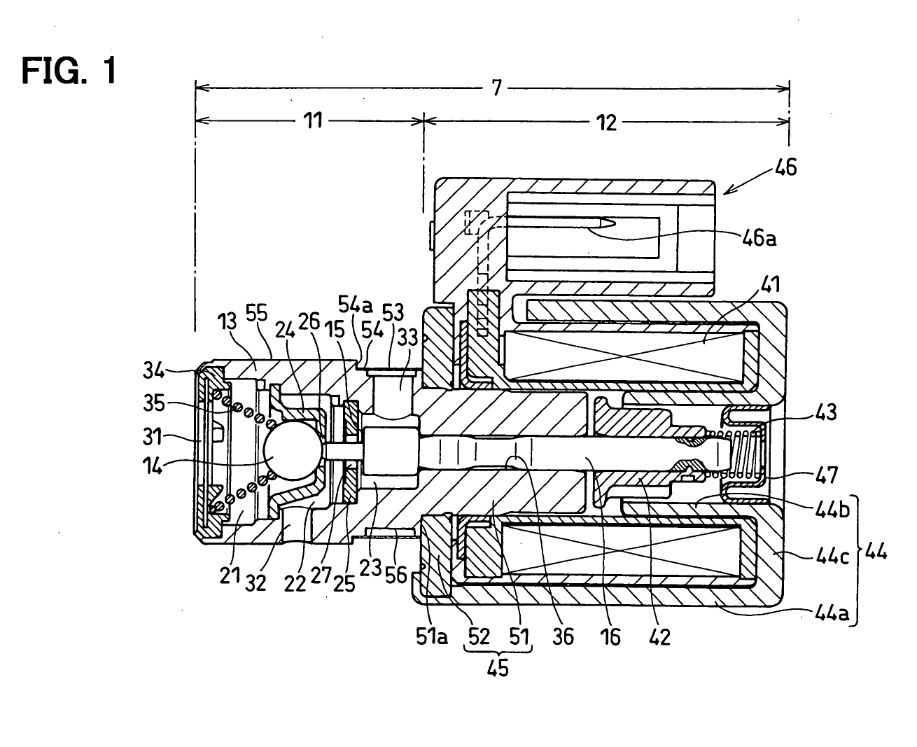

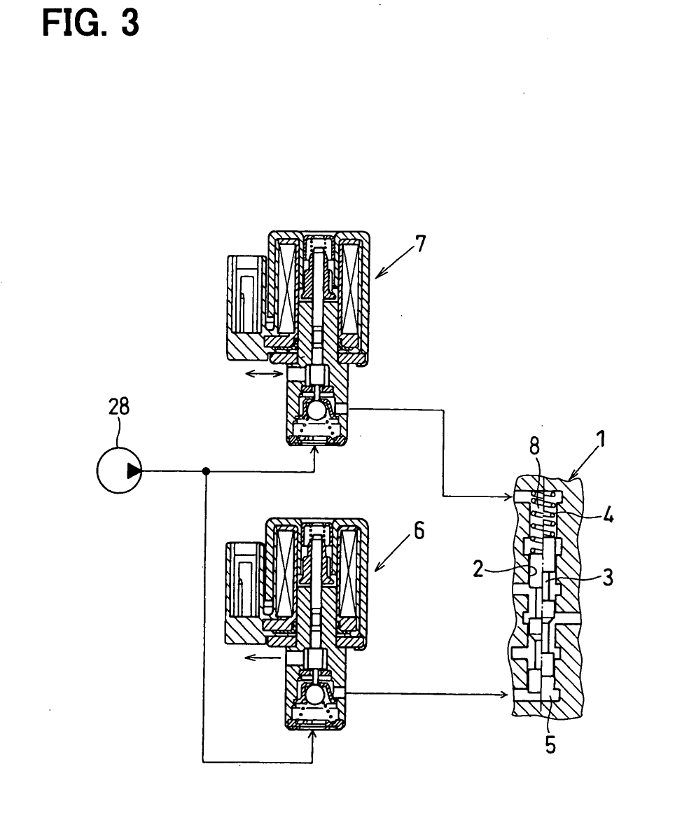

A first embodiment of the present invention will be described with reference to FIGS. 1-3. First, an oil pressure control system in which the oil pressure control valve of the present invention is used will be explained with reference to FIG. 3. The oil pressure control system includes a first oil pressure control valve 6, a second oil pressure control valve 7 and a spool valve 1. Oil is supplied from an oil pump 28 to the spool valve 1 through the first and the second oil control valves 6, 7. The spool valve 1 is connected to an automatic transmission control system.

The spool valve 1 is a known valve used in the automatic transmission control. A spool 3 is slidably disposed in a sliding hole 2 formed in a casing of an oil pressure controller. The spool 3 is biased downward (in a downward direction in FIG. 3) by a return spring 4 disposed in a spring chamber 8. A pilot chamber 5 is formed at a downward end of the sliding hole 2. Oil pressure in the pilot chamber 5 is controlled by the first oil pressure control valve 6. The spool 3 is driven against a biasing force of the return spring 4 by oil pressure in the pilot chamber 5. The first oil pressure control valve 6 is a normally-low-type control valve (i.e., oil pressure sent out therefrom is low when the control valve 6 is not energized while the oil pressure becomes high when it is energized).

The second oil pressure control valve 7 is also a normally-low-type control valve and has the same structure as the first oil pressure control valve 6. When the oil pressure in the spring chamber 8 is increased by energizing the second oil pressure control valve 7, the spool 3 is driven downward even when the oil pressure in the pilot chamber 5 is supplied by the first oil pressure control valve 6. That is, a force driving the spool 3 downward is a sum of the biasing force of the return spring 4 and the oil pressure in the spring chamber 8 supplied by the second oil pressure control valve 7. Both oil pressure control valves 6, 7 are installed in the casing of the oil pressure controller.

Now, referring to FIG. 1, a structure of the second oil pressure control valve 7 will be explained. Since the structure of both the first oil pressure control valve 6 and the second oil pressure control valve 7 is the same, the structure of the second oil pressure control valve 7 is described as a representative, and the second oil pressure control valve 7 is simply referred to as the oil pressure control valve 7 in the following description.

As shown in FIG. 1, the oil pressure control valve 7 is composed of a three-way valve 11 and an electromagnetic actuator 12. The three-way valve 11 is composed of a valve housing 13, a ball valve 14, a bleed valve 15, a shaft 16 and other components. The valve housing 13 is made of a magnetic material forming a part of the electromagnetic actuator 12. In the valve housing 13, an input chamber 21, an output chamber 22, and a bleed chamber 23 are formed in this order from the left side to the right side in FIG. 1. The input chamber 21 is a space in which a ball valve 14 is formed. The output chamber 22 is composed of a space confined by a ball valve seat 24 and bleed valve seat 25. The bleed chamber 23 is formed by a space at a right side of the bleed valve 25 inside the valve housing 13.

An inlet port 26 communicating the inlet chamber 21 with the outlet chamber 22 is formed at a center of the ball valve seat 24. An outlet hole 27 communicating the outlet chamber 22 with the bleed chamber 23 is formed at a center of the bleed valve seat 25. Both of the inlet port 26 and the outlet hole 27 are formed along an axial line of the shaft 16. The valve housing 13 includes an inlet port 31, to which the oil sent from the oil pump 28 (FIG. 3) is supplied, an outlet port 32 for supplying the oil to the spring chamber 8 of the spool valve 1, and a bleed port 33 communicating with a low pressure side such as an oil pan.

The inlet port 31 communicating with the inlet chamber 21 is formed at the left end (FIG. 1) of the valve housing 13, and the outlet port 32 communicating with the outlet chamber 22 is formed to open in the radial direction of the valve housing 13. A ball 14 forming a ball valve together with the ball valve seat 24 is biased toward the inlet port 26 by a spring 35 retained by a spring retainer 34. Communication between the inlet chamber 21 and the outlet chamber 22 is interrupted by the ball valve.

The bleed valve 15 is formed on the end of the shaft 16 positioned in the bleed chamber 23. Communication between the outlet chamber 22 and the bleed chamber 23 is interrupted by closing the outlet hole 27 with the bleed valve 15. The bleed valve 15 is pushed against the bleed valve seat 25 by energizing the electromagnetic actuator 12.

The shaft 16 is made of a non magnetic metallic material, and slidably disposed in a through-hole 36 formed in the valve housing 13. An armature 42 of the electromagnetic actuator 12 is fixedly connected to the shaft 16, so that the shaft 16 is driven together with the armature 42. Upon energizing the electromagnetic actuator 12, the armature 42 is driven to the left side (of FIG. 1) together with the shaft 16, and the left side end of the shaft 16 pushes the ball 14 to thereby open the inlet port 26. At the same time the outlet hole 27 is closed by pushing the bleed valve 15 against the bleed valve seat 25. Upon de-energizing the electromagnetic actuator 12, the shaft 16 is pushed back to the right side (of FIG. 1) by oil pressure and a biasing force of the spring 35, and the inlet port 26 is closed while the outlet hole 27 is opened.

As shown in FIG. 1, the electromagnetic actuator 12 is composed of a coil 41, an armature 42, a stator structure including a yoke 44 and stator 45, a connector 46 and other components. The coil 41 is formed by winding an insulated wire around a bobbin made of resin. Upon supplying electric power to the coil 41, a magnetic flux passing through the yoke 44, stator 45 and the armature 42 is generated. The armature 42 connected to the shaft 16 is made of a magnetic material such as iron. A spring 43 for basing the shaft toward the left side is disposed at the right side end of the shaft 16 and retained in a spring retainer 47 connected to the yoke 44. A ventilation hole is formed in the spring retainer 47.

The yoke 44 is made of a magnetic material such as iron, and is formed in a double cylindrical shape. A magnetic plate 52 is fixed to the left end opening of the yoke 44 by staking a craw portion of the yoke 44. The yoke 44 is composed of an outer yoke 44a covering an outer periphery of the coil 41, an inner yoke 44b disposed inside of the coil 41 and outside of the armature 42, and a connecting yoke 44c connecting the outer yoke 44a and the inner yoke 44b. The armature 42 is disposed with a certain air gap apart from the inner yoke 44b.

The stator 45 is composed of a small-diameter portion 51 of the valve housing 13 which is made of a magnetic material such as iron and the magnetic plate 52 fixed to the small-diameter portion 51 to abut a step 51a formed on the valve housing 13 at a boundary between the small-diameter portion 51 and a large-diameter portion 55. The magnetic plate 52 is made of a magnetic material such as iron and is formed in a round disk shape. The magnetic plate 52 is magnetically connected to the yoke 44 by staking. The right end surface of the small-diameter portion 51 of the valve housing 13 attracts the armature 42 when the coil 41 is energized. The connector 46 having terminals 46a each connected to each end of the coil 41 is electrically connected to an electronic control unit for an automatic transmission.

The first embodiment described above operates in the following manner. As explained with reference to FIG. 3, a capacity of the spring chamber 8 decreases when the first oil pressure control valve 6 is energized while the second oil control valve 7 is de-energized. The oil in the spring chamber 8 flows into the output port 32 of the second oil pressure control valve 7 and flows out from the bleed port 33. On the other hand, the capacity of the spring chamber 8 increases when the first oil pressure control valve 6 is de-energized while the second oil pressure control valve 7 is also de-energized. In this case, the oil flows from the bleed port 33 toward the output port 32. This oil flow is referred to as a reverse flow.

The oil flowing from the bleed port 33 toward the output port 32 in the reverse flow is the oil which is not cleaned by a filter such as an oil strainer. Therefore, it is possible that foreign particles contained in the oil enter into the three-way valve 11 through the bleed port 33. The foreign particles entered into the three-way valve 11 may cause operation trouble in the three-way valve 11. Therefore, a filter for preventing the foreign particles from entering the three-way valve 11 has to be provided to cover the bleed port 33. However, if the filter is simply wound around the valve housing 13 to cover the bleed port 33, various problems are involved as explained above in the BACKGROUND OF THE INVENTION.

To solve those various problems, a filter 53 is formed in a cylindrical shape in the present invention before it is installed to the valve housing 13. More particularly, the cylindrical filter 53 is mounted on the filter-mounting surface 54 before the valve housing 13 is connected to the magnetic plate 52. The filter 53 is retained between a step 54a formed at a boundary between the large-diameter portion 55 and the filter-mounting surface 54, and the magnetic plate 52 to prevent movement of the filter 53 in the axial direction.

The structure for mounting the filter 53 will be described below in detail. The cylindrical valve housing 13 includes a large-diameter portion 55, a filter-mounting surface 54 and a small diameter portion 51, formed in this order from the left side to the right side as shown in FIG. 1. At a boundary between the large-diameter portion 55 and the filter-mounting surface 54, a step 54a is formed. A circular groove 56, depressed from the filter-mounting surface 54, is formed on the filter-mounting surface 54. The filter 53 in a closed cylindrical shape is mounted on the filter-mounting surface 54 before the valve housing 13 is inserted into the magnetic plate 52.

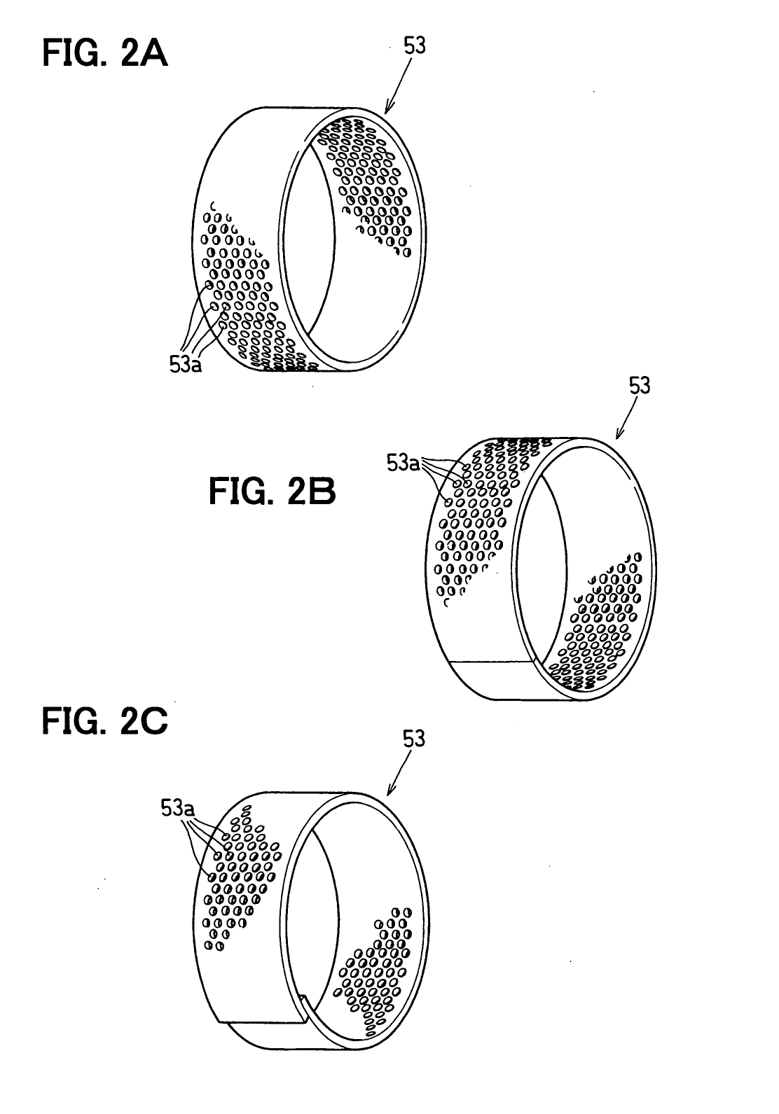

With reference to FIGS. 2A-2C, the filter 53 will be described in detail. The filter 53 is made of resin or a thin metallic plate and is formed in a closed cylindrical shape. The filter 53 may be formed as a seamless pipe as shown in FIG. 2A. It may be rounded as shown in FIG. 2B, and then abutting ends are connected by laser welding or the like. Alternatively, as shown in FIG. 2C, both ends of the filter 53 may be overlapped and the overlapped ends are connected by welding such as laser welding.

A width (a length in the axial direction) of the filter 53 is made substantially equal to an axial length of the filter-mounting surface 54. An outer diameter of the filter 53 is made equal to or a little smaller than a diameter of the large-diameter portion 55. An inner diameter of the filter 53 is made to fit the diameter of the filter-mounting surface 54. The filter 53 includes many holes 53a, each having a size that permits oil to flow therethrough but prevents passing-through of foreign particles contained in the oil. More particularly, the size of the holes 53a is made preferably in a range of 0.1 mm-0.8 mm, more preferably in a range of 0.2 mm-0.5 mm. The holes 53a may be made by radiating a laser beam, by etching, or by any other known methods.

A thickness of a plate forming the filter 53 is set to such a size that is sufficiently strong against pressure and flow of the oil and is not too resistive to the oil flow. More particularly, it is preferable to make its thickness in a range of 0.1 mm-1.0 mm in the case where the filter 53 is made of a hard metallic material such as stainless steel. When a plate is rounded and then its ends are connected as shown in FIG. 2B or 2C, it is preferable to use a plate having a thickness of 0.1 mm-0.6 mm so that the plate is easily rounded.

The filter 53 in a closed cylindrical shape is mounted on the filter-mounting surface 54 by inserting the valve housing 13 into the filter 53 before the magnetic plate 52 is connected to the valve housing 13. The filter 53 is sandwiched between the step 54a and the magnetic plate 52 so that it does not move in the axial direction. In this manner, the filter 53 is exactly positioned on the filter-mounting surface 54, correctly covering the bleed port 33 that is open to the filter-mounting surface 54. The filter 53 is easily mounted on the position without using any other additional members for holding the filter 53.

Since the filter 53 has a closed cylindrical shape, it is not opened by any outside forces such as vibration or oil pressure. Therefore, the filter 53 does not override the step 54a and does not move in the axial direction. Since the circular groove 56 depressed from the filter-mounting surface 54 is located underneath the filter 53, and many holes 53a are formed in the filter 53, an oil flow resistance can be made low. The holes 53a may be replaced with a mesh, i.e., the filter 53 may be formed from a mesh.

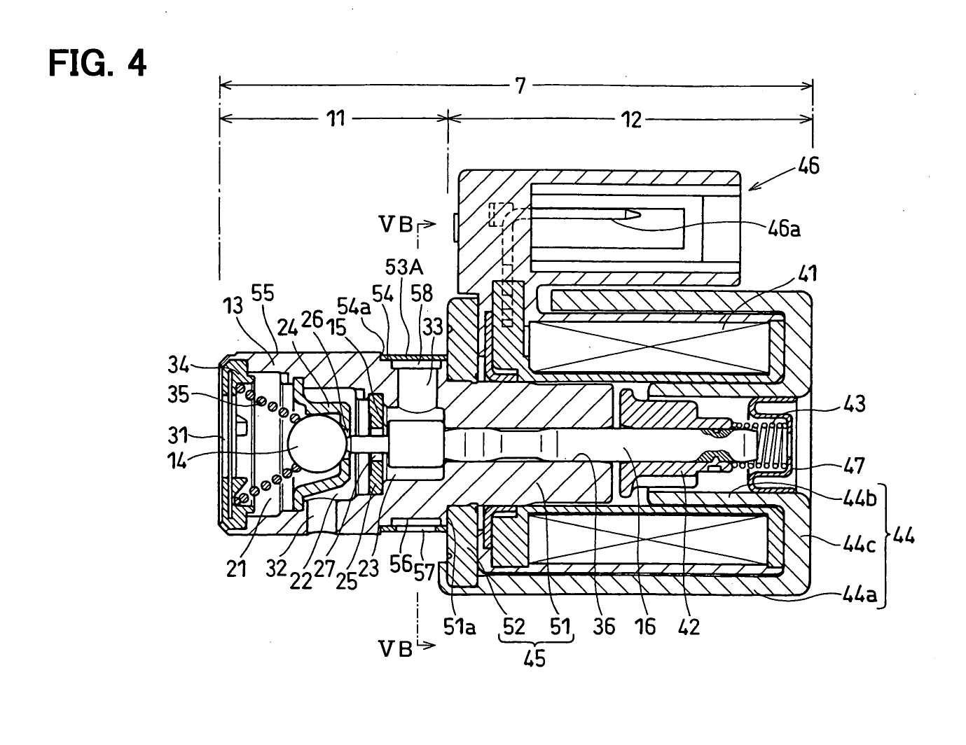

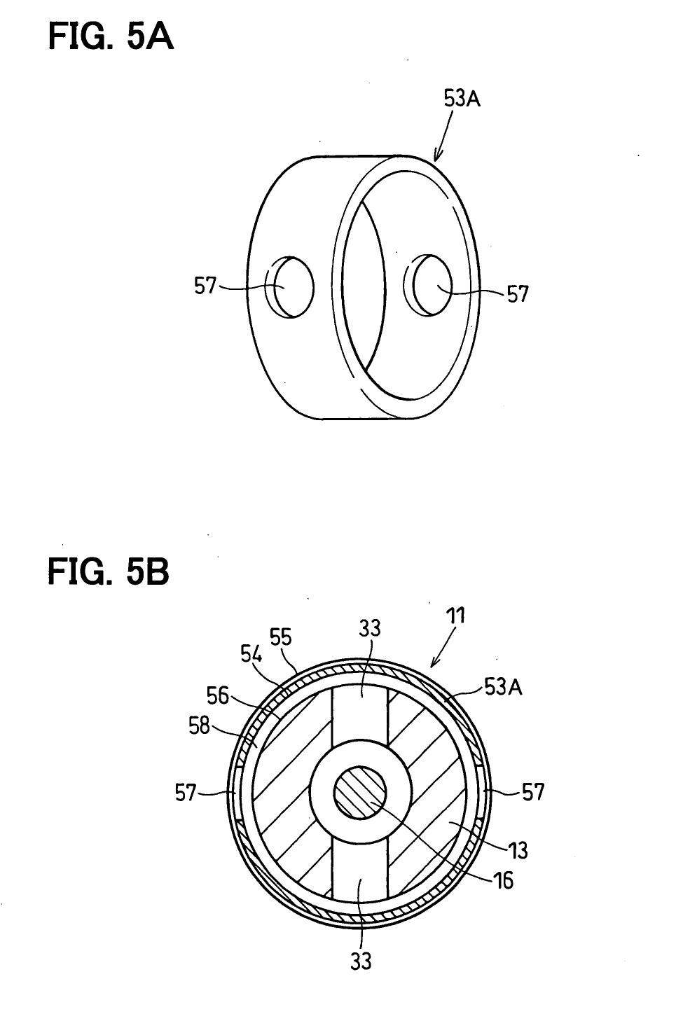

A second embodiment of the present invention will be described with reference to FIGS. 4, 5A and 5B. In this embodiment, the filter 53 having many holes 53a is modified to a filter 53A having openings 57. Other structures are the same as those of the first embodiment. As shown in FIG. 5A, two openings 57 are formed in the filter 53A in place of many holes 53a formed in the first embodiment. A size of the opening 57 is relatively large, i.e., its diameter is a little smaller than a width (an axial length) of the filter 53A.

As shown in FIG. 5B, the filter 53A is mounted on the filter-mounting surface 54, so that the openings 57 are positioned 90° apart from the bleed ports 33. An angle between the opening 57 and the bleed port 33 is not limited to 90°, but it may be variously changed in a range not overlapping each other. The filter 53A is fixed to this position by forcibly inserting the filter-mounting surface 54 into the filter 53A. The filter 53A may be fixedly positioned on the filter-mounting surface 54 by other methods than forcible insertion. When the filter 53A is positioned as shown in FIG. 5B, narrow passages 58 connecting the openings 57 and the bleed ports 33 are formed. The narrow passages 58 are formed between an inner periphery of the filter 53A and a surface of the circular groove 56.

The depth of the circular groove 56 is made so that foreign particles contained in the oil are not allowed to flow through the narrow passages 58 and the narrow passages 58 are not easily clogged. Preferably, the depth of the circular groove 56 is made in a range of 0.1 mm-0.8 mm, more preferably, in a range of 0.2 mm-0.5 mm. The oil entering the openings 57 flows into the bleed ports 33 through the narrow passages 58. Foreign particles contained in the oil are filtered in the course of its flow and are prevented from entering into the valve housing 13. The filter 53A is mounted on the filter-mounting surface 54 in the same manner as in the first embodiment.

The present invention is not limited to the embodiments described above, but it may be variously modified. Though the present invention is applied to the normally-low-type oil pressure control valve in the foregoing embodiments, it may be applied to a normally-high-type oil pressure control valve. Though the oil pressure control valve is used in an automatic transmission control system, it may be used in other systems. Though oil pressure is controlled in the foregoing embodiments, it is possible to control pressure of other liquids or fluids. In place of the three-way valve used in the foregoing embodiments, other valves may be used. The ball valve 14 used in the foregoing embodiments may be replaced with other valves. Though the electromagnetic actuator 12 is used in the foregoing embodiments, it is possible to use other actuators such as a piezoelectric actuator, an electric motor, or an oil pressure or vacuum actuator.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An oil pressure control valve driven by an actuator, comprising:
an elongated cylindrical valve housing having an oil port open in a direction perpendicular to an axial direction of the valve housing;
a valve shaft disposed in the axial direction in the valve housing to be driven by the actuator connected to the valve housing; and
a filter, formed in a cylindrical shape, for preventing foreign particles contained in oil from entering into the valve housing through the oil port, wherein:
the cylindrical filter is disposed on an outer periphery of the valve housing to cover the oil port and is sandwiched between a radial step formed on the outer periphery of the valve housing and the actuator to prevent movement of the filter in the axial direction of the valve housing.

2. The oil pressure control valve as in claim 1, wherein:
the filter is formed in a closed cylindrical shape before it is disposed on the valve housing.

3. The oil pressure control valve as in claim 1, wherein:
the filter includes a plurality of holes that permit oil to flow therethrough and prevent foreign particles in the oil to flow therethrough.

4. The oil pressure control valve as in claim 1, wherein:
the filter includes an opening positioned apart from the oil port; and
a narrow passage that permits oil to flow therethrough and prevents foreign particles in the oil to flow therethrough is formed between an inner periphery of the filter and the outer periphery of the valve housing, so that the opening communicates with the oil port.

5. The oil pressure control valve as in claim 2, wherein:
the filter is made by rounding a thin plate and then firmly connecting both ends of the thin plate.
